(19) United States
(12) Patent Application Publication
(10) Pub. No.: US 2006/0195443 A1
(43) Pub. Date: Aug. 31, 2006

(54) Information prioritisation system and method

(76) Inventors: Gary Lee Franklin, Christchurch (NZ); Grant James Ryan, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/351,583

(22) Filed: Feb. 9, 2006

(30) Foreign Application Priority Data
Feb. 11, 2005 (NZ) 538211

(51) Int. Cl. G06F 17/30

(52) U.S. Cl. 707/5

(57) ABSTRACT

The present invention relates to an information prioritisation system which is preferably implemented using at least one computer system. This prioritisation system may be adapted to execute the steps of initially receiving an input results set with this results set including a subset of at least one advertiser result. The system provided may then calculate a rank value for each result within the input results set and then assign this calculated rank value to each result of the set. The system may then subsequently order the input results set into an output results set where the output results set formed is composed of a sequential array of results ordered by the calculated rank value assigned to each result. Computer executable instructions configured to implement such a system are also considered to be within the scope of the invention.

### TECHNICAL FIELD

This invention relates to a system for prioritising information. Preferably the present invention may be implemented through an algorithm executed by a computer system to prioritise internet search engine results handled by the computer system. Reference throughout this specification will in general be made to the present invention being used in this application, but those skilled in the art should appreciate that other applications can also employ the present invention if required.

### BACKGROUND ART

Information prioritisation systems are of use in a number of information technology applications. In particular, internet based search engine service providers employ search results prioritisation systems to determine how their search results are presented to their users.

In the case of search engine providers a revenue stream can be generated through giving priority to search results from an advertiser. In return for a fee, advertiser's results or other promotional material may be displayed prominently to a user when search results related to the advertiser's activities, services or products are presented.

A common mechanism employed to determine payments to be made from advertisers is the pay per click model, which requires advertisers to bid on specific key words or search terms with the intention that their own results will be displayed with high priority when searches are made that contain those key words or search terms.

The pay per click model works well with large numbers of advertisers who provide a revenue stream for the service provider, and in turn are given access to an effective inbound channel for promotional messages to users who are actively searching in the advertiser's domain of interest.

However, the pay per click model is not as effective in situations where there are a small number of advertisers in a market segment which has a significant number of potentially relevant keywords which these advertisers are to bid on. This situation can occur and limit the effectiveness of the pay per click model when a special interest group or targeted advertising audience is to be solicited by advertisers.

Some search engine service providers implement vertical search engines for such small targeted audiences.

In these instances the search engine's advertisers need to invest a significant amount of time and human resources into bidding on the large number of key words (potentially in the order of tens to hundreds of thousands) which could be used by the targeted audience. These advertisers have limited feedback as to which keywords to bid on from the large set of keywords available, and also have limited ability to determine the relationship between their site traffic sources and volumes, and the keyword bidding strategy they employ. Due to the potentially massive numbers of relevant keywords involved it is not economic for advertisers to use the pay per click model in these applications.

These problems faced by advertisers in turn must be addressed by the vertical search engine service provider. The service provider needs to ensure that the facility they provide is usable by advertisers and is also perceived as value for money by advertisers.

One alternative model or mechanism by which the content of paying advertisers may be promoted is through the paid inclusion model. An advertiser opting for paid inclusion will have the on-line or internet based information they present subjected to detailed analysis by the indexing processes of the search engine involved. The detailed indexing of an advertiser's web site will in turn increase the priority or page rank assigned to results returning a link to a page of the advertiser's web site.

However, the paid inclusion model again is subject to a number of problems and disadvantages.

There is no guarantee offered to advertisers that their search results will be presented to a user or potential customer, and no guarantee that their search results will appear with higher priority than that of their competitors. The advertiser is required to pay for a service which is difficult for them to measure the value of. The pay per click model discussed above at least provides advertisers with an indication as to what their competitors are willing to bid and pay on particular keywords.

Users of the search engine involved may also be presented with a large quantity of results which aren't relevant to the information the user is seeking. Relevant or useful results may be buried in a number of less relevant paid inclusion results which a user must wade through find content of interest. This behaviour of the search engine can deter its users from employing it, as the search engine does not effectively provide relevant search results in a usable format.

Furthermore, the paid inclusion model does not allow an advertiser to prioritise some elements of their content above other less relevant content. An advertiser's entire web site will be indexed and mixed into the search results to be presented, irrespective the relevance of particular pages to the target audience.

An improved information prioritisation system which addressed any or all of the above problems would be of advantage. In particular, an information prioritisation system which allowed comprehensive and relevant search results or information to be presented to search engine users whilst also preferably prioritising the results of advertisers over non advertisers where results are relevant would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an information prioritisation system adapted to be implemented using at least one computer system, said prioritisation system being adapted to execute steps of:
i) receiving an input results set, said results set including a subset of at least one advertiser result, and
ii) calculating a rank value for each result within the input results set and assigning said calculated value to each result of the set, and
iii) ordering the input results set into an output results set.
   wherein said output results set is composed of a sequential array of results ordered by the calculated rank value assigned to each result.

According to a further aspect of the present invention there is provided an information prioritisation system substantially as described above wherein the calculation of a rank value for each result within the input results set includes the steps of:
a) receiving a result rank assigned to each member of the input results set, and
b) calculating a relevance factor for at least one advertiser result present within the input results set, and
c) modifying the result rank assigned to said at least one advertiser result based on the relevance factor calculated for said at least one advertiser result.

According to a further aspect of the present invention it is provided an information prioritisation system adapted to be implemented using at least one computer system, said prioritisation system being adapted to execute the steps of;
i) receiving a result rank assigned to each member of an input results set, and
ii) calculating a relevance factor for at least one advertiser result present within the input results set, and
iii) modifying the result rank assigned to said at least one advertiser result based on the relevance factor calculated for said at least one advertiser result
iv) ordering the input result set into an output results set, and
v) presenting the output result set to a user, and
vi) recording the users selection of at least one result from the output results set, and
vii) modifying a relevance factor associated with said selected result.

According to a further aspect of the present invention there is provided an information prioritisation system substantially as described above wherein the rank calculated includes a discard rank value, where said discard rank value being associated to a result prevents the result being integrated into the output result set.

According to a further aspect of the present invention there is provided computer executable instructions stored on a computer readable medium, said instructions being adapted to execute the steps of;
i) receiving an input results set, said results set including a subset of at least one advertiser result, and
ii) calculating a rank value for each result within the input results set and assigning said calculated value to each result of the set, and
ii) ordering the input results set into an output results set.
   wherein said output results set is composed of a sequential array of results ordered by the calculated rank value assigned to each result.

According to another aspect of the present invention there is provided computer executable instructions substantially as described above wherein the calculation of a rank value for each result within the input result set includes the steps of;
a) receiving a result rank for each member of the input results set, and
b) calculating a relevance factor for at least one advertiser result present within the input results set, and
b) modifying the result rank assigned to said at least one advertiser result based on the relevance factor calculated for said at least one advertiser result.

The present invention is adapted to provide an information prioritisation system. Such a system may implement a method of processing through computer executable instructions loaded into at least one computer system. Reference throughout this specification will in general be made to the present invention providing an information prioritisation system through a computer system running computer executable instructions. Those skilled in art should also appreciate that such computer executable instructions and the methodology described for the present invention are also within its scope.

In a preferred embodiment the present invention may be used in conjunction with an internet search engine, and in further preferred embodiments may be employed with a vertical search engine to search online resources available to a special interest group of users. In such applications the information to be prioritised may consist of “results” presented to users by the search engine involved where this result information indicates to a user the availability of particular on-line content which is associated with or related to a search term previously entered by the user. Such search terms can be employed by the search engine to present a prioritised list of results to a user where each result is linked to a specific destination which provides the content indicated by the basic result entry.

The term ‘search engine’ is not necessarily restricted to Internet search engines and may also include any other electronic data search systems for interrogating databases and or networks. Although the present invention is described herein with respect to an Internet search engine, it should be understood this is for exemplary purposes only and the invention is not necessarily limited to internet application.

In such applications a search term may be defined as any key words, images, audio, video, alphanumeric data, and/or any other query used as user input for searches to be performed by a search engine.

Although the present invention is applicable for search engines utilized on any suitable network including local and wide area networks (LAN and WAN respectively), intranets, mobile phone services, text messaging, and the like, it is particularly suited to the internet and the invention is described henceforth with respect to same. It will be appreciated this is exemplary only, and the invention is not limited to internet applications. Consequently, although the term destinations encompasses not only web sites and web pages but also any discrete searchable information item such as images, downloadable files, specific texts, or any other electronically classifiable and/or searchable data, reference is made henceforth to data items as internet web pages.

Furthermore those skilled in the art should appreciate that the term computer system is used throughout this specification may include a single instance or stand alone computer and alternatively a network of computers connected together locally or from a number of remote locations. Those skilled in the art should appreciate that numerous computer system architectures may be employed in conjunction with the present invention. However, for the sake of clarity throughout this specification discussion will be made of a computer system being provided by a single local computer system running a web server and also the basic search engine processes required to implement a search engine.

Reference throughout this specification will also in the main be made to the present invention being adapted to provide an information prioritisation system. Again however, those skilled in the art should appreciate that computer executable instructions loaded onto a computer system may provide such an information prioritisation system. Furthermore, such computer executable instructions may be adapted to execute a method of prioritising information in accordance with the present invention.

In a preferred embodiment the prioritisation system provided is adapted to receive an input results set. As discussed above such an input results set may be formatted in terms of basic search engine results, which are to be prioritised based on their potential relevance to a user, and in a preferred embodiment, based on historical relevance to past users.

In a preferred embodiment the input results set received with the present invention may also include a sub set of results provided by an advertiser with a commercial relationship with the search engine. Preferably these advertiser results may be selected and entered into the input results set through having a relationship with an initial search term entered by a user. The overall input results set generated by the search engine can therefore include a mixture of both advertiser and non-advertiser results where all these results could potentially be of interest to the user currently completing a search.

In a preferred embodiment advertiser results may be identified through a previous paid inclusion indexing process executed by the search engine. Relatively exhaustive paid inclusion indexing processes may be executed on an advertiser's internet content to increase the pool of results available from an advertiser. In effect there may be little difference in between an advertiser and non-advertiser result apart from the advertiser result being flagged as a result selected for special treatment in accordance with the methodology of the present invention.

In a preferred embodiment the prioritisation system provided may be adapted to calculate a rank value for each result received from the input result set. These calculated rank values may then be assigned to each result of the input set.

In a preferred embodiment the prioritisation system may initially receive or calculate a result rank to be assigned to each and every result within the input results set, irrespective of whether the result is an advertiser or non-advertiser result. The initial result rank applied may preferably use standard search engine ranking or prioritisation techniques to assign rank values which give a higher rank to results which could potentially be more relevant to the searching user. Those skilled in the art should appreciate that such basic search engine prioritisation techniques are well known and may be implemented by any number of a multitude of methods.

In a further preferred embodiment the initial result rank applied to each advertiser result may be subsequently modified to potentially give preference or higher priority to advertiser's results over non-advertiser results. However, it is also envisioned that these further processes executed with respect to the rank of advertiser results may also demote or lower the priority of advertiser results, or in some instances remove the result entirely from an output result set to be generated in conjunction with the present invention. The specific process or processes to be executed in relation to the rank of advertiser results is discussed further below.

Preferably once each and every member of the input result set has a rank value assigned, an output result set may be generated. Such an output result set may be implemented through ordering the input result set based on the priority assigned to each member of the input results set. Furthermore, a priority may be assigned to a result indicating it should be discarded or not included within the output results set for the search tern involved. In such instances the output result set may be formed from a prioritised array of all the results in the input results set, or alternatively through a prioritised array of results selected from the input results set.

In a preferred embodiment the step of calculating a rank value for each result may include the determination of whether a discard rank value is to be assigned to a result. In such instances characteristics parameters of the result, the search term employed to select a result, the destination associated with the result, or the ownership or relation of a result to a particular advertiser may be taken into account in isolation or in combination to determine whether a discard rank should be applied to a particular result for the search term involved.

For example, in some embodiments a discard rank may be applied to particular results (and preferably advertiser results) depending on;
the characteristics of the content present in the destination associated with a particular result (such as whether the destination includes or excludes particular information indicated as important by an advertiser).
a threshold number of advertiser results having previously being integrated into the input result set. Preferably a minimum or maximum threshold number may be considered for a particular advertiser to determine whether a further result from the same advertiser should be discarded.
any other customised or manual characteristic testing rules required by the specific application in which the present invention is to be used.

Those skilled in the art should appreciate that the application of a discard rank via the prioritisation system may be employed to filter and potentially prioritise an advertiser's result and associated destination, where these results are incorporated into the input results set using paid inclusion techniques. Paid inclusion can result in a large number of results being provided in an input results set which are not particularly relevant to a searching user but which yet are still valid results from an advertisers web-site. Through the application of a discard rank this customised prioritisation process may be executed on such advertiser results to ensure that users are more likely to consider results and their associated destinations which the advertiser wishes to have presented.

In addition to or alternatively instead of the application of discard rank values the present invention may calculate a relevance factor for at least one of the advertisers results present within the input results set. In a further preferred embodiment a relevance factor may be calculated for every advertiser result to be integrated within the output result set. The use of such a relevance factor may be employed to modify the basic result rank initially calculated for all the advertiser results present within the input set. This can both promote the priority of advertiser results set which are likely to be of relevance to users, in addition to demoting the priority of advertiser results which are less likely to be of use.

In a preferred embodiment, a relevance factor of a result may be calculated directly from a cumulative tally of the number of times the result has previously been selected by a user completing a search with the search term used to generate the input result set. In such instances the search term involved will be deemed by the searching user to be characteristic of particular content associated with the results, with the selection of the result involved validating this relationship and hence promoting the relevance of the result in relation to the particular search term used.

This may be contrasted with a conventional prior art search engine which typically provides a ranked search result listing based on a) keyword frequency and meta tags; b) manual evaluation of web site by professional editors; c) advertising fees, and d) link analysis or a combination of same. Improvements over these methods are afforded by the technology employed in the applicant's earlier patent filings, US6421675, U.S. Ser. Nos. 09/115,802, 10/155,914, 10/213,017 NZ518624 and NZ528385 to applying weighting to the search results by increasing (and/or optionally decreasing) the ranking of a previously selected destination and result pair over an unselected destination and result pair within the input results set.

U.S. Pat. No. 6,421,675, U.S. Ser. Nos. 09/155,802, and 10/213,017 disclose a means of refining searches according to the behavior of previous users performing the same search. These patent filing disclose harnessing the discriminatory powers of the user to effectively provide a further filtering and screening of search results to the subsequent behavior when presented with search results listings. If a particular search result or distinction is deemed to be of greater relevance for a particular search term, the user will typically access the website for some duration and/or perform other activities denoting a relevant website such as clicking on embedded links therein, downloading attachments, and the like. By preferentially weighting the relevance of search results according to the user's behavior in relationship to a particular search query, the search engine is able to enhance the relevance of the search result listings.

For example, in a preferred embodiment a relevance factor may be determined for results through a learning process implemented over a large number of search terms, and results with their associated destinations substantially as described in the above patent filings. Previous user behaviour may validate the relevance of a particular result with respect to the search term supplied by a user. This relevance characteristic may be further amplified through subsequent validating clicks from other users which strengthens the relevance relationship between the search term entered and the destination associated with the result involved.

For example, in one preferred embodiment a relevance factor may be calculated from a cumulative record on the number of times a particular link has been selected or clicked through on previously by a user in relation to a particular search term. This cumulative relevance factor can then in turn reflect how many times users have validated the relevance of the result and its associated destination to the search term involved. The result rank of the result involved may then be modified by a mathematical process or algorithm to promote the priority of results with a high relevance factor and to demote the priority of results with a low relevance factor.

Reference throughout this specification will also be made to the calculation of a single independent relevance factor for each instance of an advertiser result. However, in other embodiments clusters or collections of advertiser results may be associated with a single or common relevance factor if required. For example, in such instances the learning process discussed above may be implemented on a broader scale to treat all results from a particular advertiser as equivalent, with any subsequent user's selection or validation of the relevance of an advertiser result being counted towards the relevance of all results from the advertiser involved. In such instances user behaviours may indicate that destinations associated with a particular advertiser are consistently considered to be relevant, hence therefore, all results from this advertiser may be prioritized according to a common relevance factor applied across all results.

Furthermore, in another embodiment, the calculation of a relevance factor may not necessarily rely on the implementation of a user behaviour based learning process substantially as described above. For example, in some alternative embodiments, a profile or other form of identification of the searching user may be employed to modify a results relevance factor. For example, in some instances an internet address or alternatively cookie based information residing on a users computer may indicate that the user is of value to a particular advertiser and has for example previously made a number of important or high value purchases from a specific advertiser. The presence of such high value users on the search engine interface website may trigger the re-prioritisation of specific advertiser or advertisers search results up or down depending on the potential value of the user involved to particular advertisers.

Reference throughout this specification will however be made in general to a relevance factor associated with a result being modified through user behaviour based learning processes discussed above. However, those skilled in the art should appreciate that other mechanisms for calculating and/or modifying a relevance factor are envisioned and also within the scope of the present invention.

In a preferred embodiment, a relevance factor may be implemented through or formed as a single integer number which is to be added to an integer number based result rank calculated for each result involved. An integer based relevance factor can then increase the priority of a result as a negative value or alternatively decrease the priority of the result as a positive value, where a low value of a result rank indicates a high priority. For example, as discussed above where a relevance factor is implemented through a user behaviour based learning process, each and every ‘click’ or selection recorded against an advertiser result may add negative one to an initially zero starting relevance factor for such a result.

However, those skilled in the art should also appreciate the relevance factor may not necessarily be provided in all embodiments through a single integer number or value. For example, in other instances the relevance factor may be implemented through a formulaic transformation acting on an initial input result rank. Various mathematical operators and associated variables may be employed within such a formula if required.

In some instances, the magnitude or strength of a relevance factor may also be modified by further processes depending on a particular commercial arrangement between the search engine provider and the advertiser involved. In such instances further modification, amplification, decay or damping processes may be executed in relation to the calculation of the relevance factor discussed above, and potentially due to a payment scheme and results treatment scheme offered by a search engine provider and accepted by an advertiser.

Preferably in some embodiments a decay weighting may be applied to the previous selection of a result by a user depending on the amount of time which has passed since the result was selected. In some instances a decay weighting can reduce the effect of a subsequent selection of a result on the relevance factor calculated.

In one embodiment a time dependence decay process may be applied in the calculation of a relevance factor. In such instances the time elapsed since relevance validating clicks were made by users may be taken into account to slowly allow the relevance factor of a result to decay over time if this relevance characteristic is not frequently revalidated by further clicks from users. Preferably the rate of decay of older relevance validating clicks may be increased or decreased depending on a commercial arrangement or plan put in place between the search engine service provider and an advertiser. Specific commercial arrangements may be implemented so that an advertiser may pay to have the relevance factor associated with its result decay more slowly than a default rate or alternatively a discount on fees may be provided if such validating clicks decay faster than would normally be experienced.

For example in one such alternative embodiment a history factor maybe implemented as discussed below as a formulaic transform applied to an initial input result rank. Such a process is disclosed in U.S. Pat. No. 6,421,675 which discloses a history factor which is a variable number between 0 and 1 used in conjunction with a particular key word and search result, so that a search result perceived relevance does not last indefinitely. In one embodiment, the search result rank integer X may be a result rank updated over a predetermined period according to the relationship:
X(new)=(X(old)·HF)+α.

Where X(new) is the new calculated search result rank, X(old) is the previously calculated value, HF is the history factor and α is the number of user accesses of the search result over the predetermined period for a particular query. Thus, the history factor HF preferentially biases the most recent user accessing of the search result over the previous activities.

Utilising the above techniques the present invention may preferentially favour advertiser results by changing the history factor to give a lower final rank. Thus, according to one embodiment, an advertiser search results history factor (ASRHF) with a value greater than the history factor associated with the other displayed search results will eventually promote the priority of these advertiser results.

Preferably an amplification weighting may be applied to a previous user selection of a result when a relevance factor is calculated for the result. Such an amplification weighting may be employed to promote the relevance of a result with respect to a specific search term on the basis of an agreement between the search engine operator and advertiser associated with the result.

For example, in other instances (or potentially in combination with the modification of decay rates discussed above) a popularity or relevance amplification process may also be implemented in the calculation of a relevance factor, again depending on a commercial arrangement between the search engine service provider and advertiser. In such instances the weighting given to single instances of validating clicks from users may be multiplied over a standard weighting or alternatively may be eroded depending on an agreement between a service provider and advertiser.

For example an embodiment where a comparatively relevance factor is implemented through a numerical integer count of cumulative selections of an advertiser's result, this count may be incremented by more than one for each and every selection of the result involved. For instance, some instances the relevance factor count can be incremented by five on each selection of the result to promote or amplify the perceived relevance of the advertiser result for each and every selection by a user.

The advantage of this method is that if advertiser results are shown and if they are deemed to be totally irrelevant (ie no users click on them) then over time they will not be shown for particular search terms. If the results are relevant they will receive a priority boost and be more likely to be presented to a searching user in the output result set in the first few initial results displayed to the user than equivalently relevant non-advertiser results.

The above techniques may be employed in combination or isolation together with the calculation and subsequent modification of a relevance factor. User behaviour feedback monitoring processes may be employed to successively modify the relevance factors calculated to preferably promote the priority of advertiser results and non-advertiser results where each are of similar relevance.

In a preferred embodiment a customised prioritisation process may also be implemented to modify the initial result rank applied to an advertisers result outside of the learning based relevance factor technique discussed above. For example, in some instances an advertiser may wish to guarantee that a particular advertiser result associated with a specific search term will be presented within the first ten results to be displayed to a user. In such instances a manual reordering or reprioritisation process may be implemented to arbitrarily assign a required priority to an advertiser result based on a previous commercial agreement or arrangement between the search engine service provider and the advertiser involved.

The techniques and methodology discussed above may provide a workable and potentially advantageous result prioritisation system and also allows for new methods of charging advertisers for relevant priorities within output results sets. In the instance where a paid inclusion model is initially used to introduce a larger number of advertiser results, these results can be prioritised depending on their relevance, therefore ensuring that the most important or useful results are presented to searching users over less relevant content contained within an advertisers website.

These techniques can be of particular advantage when a specific targeted audience is to be reached through, for example, a vertical search engine facility. The comparatively low number of advertisers involved with such vertical channels in combination with a potentially large set of key words or search terms which may be entered can be dealt with through reprioritising advertiser results introduced through a paid inclusion process.

Where relevance factors are calculated through investigation of previous selections of a result by a user employing a vertical search engine, these measures of relevance may be much more accurate or targeted for the particular subgroup or community involved. In some communities of searching users may employ their own subset of language or “jargon” or may assign different meanings to plain language terms than those normally employed by a general population of users. For example, the term ‘thruster’ employed by a general population may be considered to relate to some form of vehicle propulsion system. Conversely, in the context of a community of surfing enthusiasts the same term will be understood to represent a design of surfboard.

The present invention may also facilitate the delivery of traffic analysis reports periodically to an advertiser from a search engine service provider. Such traffic reports may incorporate information with respect to the number of times an advertiser's destination was reached through one of the results presented in combination with the search term employed by the user. Advertisers may also be informed of the most popular search terms employed by their target audience and also may be given information with respect to which of these top terms were responsible for traffic being referred to their website, and also which pages or destinations this traffic was referred to.

This reporting process can give an advertiser a clear indication of the value of their commercial arrangement with the search engine provider and also provide them with some feedback regarding the key words or search terms employed by the audience they wish to target. Advertisers may be provided with indications of the most popular search terms for their target audience. This allows advertisers to consider using a pay per click payment model and bidding on a specific popular key word in addition to or as an alternative to the mechanisms discussed above. Such search term information may also be used to allow advertisers to bid on groups or blocks of key words and also can be employed by advertisers to assess the value of the service offered and the amounts they would be willing to pay for such a service.

Through use of the present invention advertisers may identify key words that add the most value to their organization and potentially also pay a premium to the search engine provider for referrals from such valuable key words. The present invention may also allow advertisers to instigate a differential charging or payment scheme for further key words which may be reasonably but not highly important.

This ability to focus on the most relevant keywords as well as the ability to index and extract the potentially relevant keywords from the advertiser web site or content allows new relationships and methods to be formed. For example, a traditional print publisher or media company can choose to place in a book or magazine or television show or film the web address of a dedicated vertical search engine specific for it. They can be confident that relevant material from their web site corresponding to their property, as well as specifically indexed content from their property itself, will be visible to users of the vertical search engine with higher priority, but that also relevant content from outside their site or publication will be visible and therefore of use.

These same mechanisms may also be employed in conjunction with key word or search term relationship discovery processes as discussed in the applicant's previous patent filings including, but not limited to US 6421675. The mechanism's described in this patent to identify clusters of related key words, (potentially to suggest alternative key words to a searching user) may be employed in conjunction with present invention to present an advertiser with a cluster or block of related key words to bid on.

Such reporting processes may also be extended to identify searching users which become high value customers of advertisers to which their traffic is referred to. Records may be kept by advertisers and shared with a search engine service provider to identify such high value users through cookie, IP address or other related available data prior to a search being completed by such a user. On identification on high value users, specific advertiser results may be assigned a higher priority in return for a fee paid to the search engine provider.

Furthermore, such reporting information also allows for new pricing mechanisms to be employed by a search engine service provider. Bulk traffic directed or referred to an advertiser's site could be priced based on for example;
a flat fee or alternatively a negotiated service price agreed by the advertiser and service provider, or
the average price of the top twenty search terms used by the targeted audience involved where this price is calculated on a pay per click model, or
the average cost per click of the search terms used by the targeted audience involved based on a pay per click model.
a price per sale or percentage of profit or revenue from sales generated by traffic referred.

Those skilled in the art should appreciate that these pricing mechanisms are provided by way of example only and reference to the above only throughout this specification should in no way be seen as limiting.

The present invention as described above may provide many potential advantages over the prior art. In particular the present invention may provide advantages to advertisers entering into a commercial arrangement with a search engine provider, as well as providing advantages to the search engine provider for allowing them to sell their services more readily.

Furthermore, users of the search engine provided are also provided with an effective information search mechanism which can prioritise search results at least in part based on their relevance to the search query entered. Users will still be presented with relevant search results formatted with a high priority, where these search results also give priority to advertiser results over non-advertiser results where each result has a similar or equivalent relevance to the query involved.

Advertisers can have some certainty with respect to the targeted audience they wish to reach when dealing with a vertical search engine, without necessarily having to submit bids on large numbers of key words where they are unsure as to the value of each key word. Automated mechanisms may also be put into place to track traffic generated for advertisers and how this traffic was generated in relation to particular results or destination pages offered by the advertiser.

These advantages also flow on to the search engine provider which can easily demonstrate to their advertiser customers the utility and value in the offerings and can also allow a significant degree of flexibility with respect to charging and service provision models which may be implemented.

### BRIEF DESCRIPTION OF DRAWING

Further aspects of the present invention will become apparent from the following description which is given by way of example only and with reference to the accompanying drawing in which:

FIG. 1 illustrates a block schematic flow chart of steps executed by a computer system programmed to implement the present invention in a preferred embodiment.

### BEST MODES FOR CARRYING OUT THE INVENTION

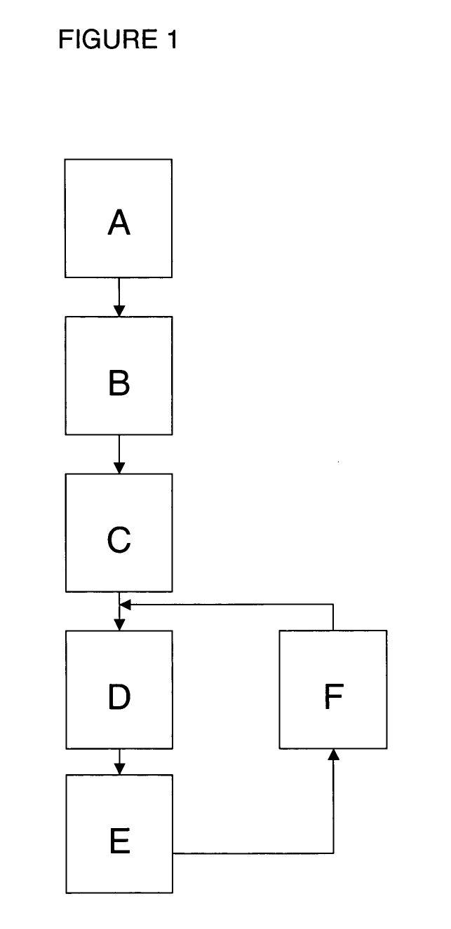

FIG. 1 illustrates a block schematic flow chart of steps executed by a computer system programmed to implement a method of information prioritisation provided in a preferred embodiment.

The initial step of the process executed is shown in step ‘A’ where the computer system receives an input results set generated through the basic operation of an internet search engine. This results set is generated based on a received search term supplied by a user which characteristic of a particular type of content or subject matter which the user wishes to receive results for. Within the input results set received are collections of advertiser results and non-advertiser results.

At the second step ‘B’ of this process each and every result within the input results set is ranked and has a basic result priority applied or associated. This basic result priority takes no account of any relationship between the search engine provider and advertisers, and simply assigns a priority to each result based on potential relevance using prior art techniques.

The third step ‘C’ of this process is implemented through the computer system involved determining which (if any) of the results within the input set are to have a discard priority assigned. The application of a discard priority prevents the result involved from being presented to the searching user. In one preferred embodiment this discard assignment process can be implemented to discard advertiser results associated with pages present within an advertiser's website which the advertiser does not wish users to visit. Such discarded destinations can potentially include irrelevant subject or subject matter which may be slightly related to the search term entered but may not be as relevant as other content or destinations available from the advertiser.

At stage ‘D’ of this process each and every advertiser result present with the input set which has not had a discard rank applied will have a relevance factor calculated. This relevance factor preferably employs learning techniques to rely on previous user behaviour to indicate whether the particular result and associated destination is particularly relevant to the search term entered by the current user. This relevance factor can then be used to subsequently modify, increase or decrease the original result priority applied to the advertiser's results within the input set.

Those skilled in the art should appreciate the exact process implemented at this stage can be dictated by the commercial relationship present between the advertiser and the search engine provider. However, in one preferred instance an advertiser may pay to prevent the effect of old relevance validation behaviour of users from decaying. Alternatively, mechanisms may be employed to amplify the perceived popularity or relevance of a result and the effect on the relevance factor calculated when compared with standard relevance calculation techniques.

In a preferred embodiment a comparatively simple process may be executed in the calculation or modification of the relevance factor involved. Preferably this relevance factor may be formed from a cumulative tally recording the number of times a particular advertiser result has been selected by a searching user in relation to a specific search term or search query. This relevant factor may then be subtracted from an integer based result rank or priority to promote the priority of an advertiser result which is has previously been deemed by users to be relevant to a particular search term. At this stage, the initial result rank generated may then be modified using the relevance factor calculated.

At the next stage ‘E’ of this process each of the results remaining which have not had a discard priority applied are sequenced into an array ordered by the priority applied to each result. The modifications made to the result priority applied to advertiser results will then reshuffle the order of results preferably to provide an increased priority to advertiser results over non-advertiser results.

Stage ‘E’ of this process also encompasses presenting an output result set (formed by the sequenced array of results) to a searching user. The format or presentation of this output result set will give prominence to results accorded a high priority (effectively with a low numerical rank) and therefore improve the chances of such results being selected by users as relevant to their search term or search queries.

A feedback loop is also provided through stage ‘F’ of this process. At stage ‘F’ the selection of the user of a particular result is recorded and identified. This user selection of a result is then used to modify or update a relevance factor which may be associated with the selected result. Users clicking on or selecting such results validate the relevance of the result to the search query involved, therefore requiring modification of the current relevance factor calculated for the result.

In the case of a preferred embodiment of the present invention the detection of a user selecting a particular advertiser result will increment a numerical integer value providing the relevance factor, by one or potentially more depending on prior commercial arrangement agreed with the advertiser and the search engine service provider.

Aspects of the present invention have been described by way of example only and it should be appreciated that modifications and additions may be made thereto without departing from the scope thereof as defined in the appended claims.

1. An information prioritisation system adapted to be implemented using at least one computer system, said prioritisation system being adapted to execute:
i) receiving an input results set, said results set including a subset of at least one advertiser result, and
ii) calculating a rank value for each result within the input results set and assigning said calculated value to each result of the set, and
iii) ordering the input results set into an output results set,
wherein said output results set is composed of a sequential array of results ordered by the calculated rank value assigned to each result.

2. An information prioritisation system as claimed in claim 1 wherein the calculation of a rank value for each result within the input results set includes:
a) receiving a result rank for each member of the input results set, and
b) calculating a relevance factor for at least one advertiser result present within the input results set, and
c) modifying the result rank assigned to said at least one advertiser result based on the relevance factor calculated for said at least one advertiser result.

3. An information prioritisation system as claimed in claim 1 wherein an input results set is supplied by a vertical search engine.

4. An information prioritisation system as claimed in claim 3 wherein advertiser results are included for advertisers with a commercial relationship with the vertical search engine.

5. An information prioritisation system as claimed in claim 1 wherein advertiser results are identified through a paid inclusion indexing process.

6. An information prioritisation system as claimed in claim 1 wherein the rank value calculated includes a discard rank value, where said discard rank value being associated to a result prevents the result being integrated into the output results set.

7. An information prioritisation system as claimed in claim 6 wherein a discard rank is applied to a result if a threshold number of advertiser results have been integrated into the input results set.

8. An information prioritisation system as claimed in claim 6 wherein a discard rank is applied to a particular result depending on content associated with said result.

9. An information prioritisation system as claimed in claim 2 wherein a relevance factor is calculated from a cumulative tally of the number of times a result has previously been selected by a user completing a search with the search term used to generate said input results set.

10. An information prioritisation system as claimed in claim 9 wherein a decay weighting is applied to the previous selection of the result by a user depending on the amount of time which has passed since said result was selected.

11. An information prioritisation system as claimed in claim 10 wherein the decay weighting applied reduces the effect of older selections of the result when compared with recent selections of the result when a relevance factor is calculated.

12. An information prioritisation system as claimed in claim 9 wherein an amplification weighting is applied to a previous user's selection of a result when a relevance factor is calculated for said result.

13. An information prioritisation system as claimed in claim 12 wherein an amplification weighting is applied depending on an agreement between the search engine provider and an advertiser.

14. An information prioritisation system as claimed in claim 2 wherein a relevance factor for at least one result is calculated based on the identity of a searching user.

15. An information prioritisation system as claimed in claim 14 wherein cookie based information residing on a searching user's computer system is used to identify a user.

16. An information prioritisation system as claimed in claim 2 wherein a single advertiser result is associated with a relevance factor.

17. An information prioritisation system as claimed in claim 2 wherein a collection of advertiser results are associated with a common relevance factor.

18. An information prioritisation system as claimed in claim 17 wherein user behaviour associated with any member of the collection of advertiser results is employed to modify the common relevance factor associated with said collection of advertiser results.

19. An information prioritisation system adapted to be implemented using at least one computer system, said prioritisation system being adapted to execute:
i) receiving a result rank assigned to each member of an input results set, and
ii) calculating a relevance factor for at least one advertiser result present within the input results set, and
iii) modifying the result rank assigned to said at least one advertiser result based on the relevance factor calculated for said at least one advertiser result, and
iv) ordering the input results set into an output results set, and
v) presenting the output results set to a user, and
vi) recording the users selection of at least one result from the output results set, and
vii) modifying a relevance factor associated with said selected result.

20. Computer executable instructions stored upon a computer readable medium, said instructions being adapted to execute:
i) receiving an input results set, said results set including a subset of at least one advertiser result, and
ii) calculating a rank value for each result within the input results set and assigning said calculated value to each result of the set, and
iii) ordering the input results set into an output results set,
wherein said output results set is composed of a sequential array of results ordered by the calculated rank value assigned to each result.

21. Computer executable instructions as claimed in claim 20 wherein the calculation of a rank value for each result within the input results set includes:
a) receiving a result rank for each member of the input results set, and
b) calculating a relevance factor for at least one advertiser result present within the input results set, and
c) modifying the result rank assigned to said at least one advertiser result based on the relevance factor calculated for said at least one advertiser result.

22. Computer executable instructions as claimed in claim 20 wherein the rank value calculated includes a discard rank value, where said discard rank value being associated to a result prevents the result being integrated into the output results set.

23. Computer executable instructions as claimed in claim 21 wherein a relevance factor is calculated from a cumulative tally of the number of times a result has previously been selected by a user completing a search with the search term used to generate said input results set.

24. Computer executable instructions as claimed in claim 23 wherein a decay weighting is applied to the previous selection of the result by a user depending on the amount of time which has passed since said result was selected.

25. Computer executable instructions as claimed in claim 23 wherein an amplification weighting is applied to a previous user's selection of a result when a relevance factor is calculated for said result.
